(19) United States
(12) Patent Application Publication
(10) Pub. No.: US 2011/0032721 A1
(43) Pub. Date: Feb. 10, 2011

(54) VEHICULAR LAMP

(75) Inventors: Hiroya Koizumi, Shizuoka (JP); Kenji Nobuhara, Shizuoka (JP); Kazunori Natsume, Shizuoka (JP)

Correspondence Address: OSHA LIANG L.L.P., TWO HOUSTON CENTER, 909 FANNIN, SUITE 3500, HOUSTON, TX, 77010, US

(73) Assignee: KOITO MANUFACTURING CO., LTD., Tokyo (JP)

(21) Appl. No.: 12/847,658

(22) Filed: Jul. 30, 2010

(30) Foreign Application Priority Data
Aug. 4, 2009 (JP) 2009-181753

(51) Int. Cl. F21S 8/10; B23P 11/00

(52) U.S. Cl. 362/519; 29/428

(57) ABSTRACT

A vehicular lamp includes a body that opens forward; an outer cover attached to the body so as to cover the opening; a first light source disposed within a lamp chamber formed from the body and the outer cover; an optical member that reflects first light source light from the first light source forward; a second light source disposed within the lamp chamber; and a light guide in which an end portion thereof receives second light source light from the second light source and an extended side surface thereof radiates forward at least a portion of the second light source light. The light guide is provided at a position that does not block a light component that forms a main light distribution of the first light source light.

### BACKGROUND OF INVENTION

1. Field of the Invention

The present invention relates to a vehicular lamp. More specifically, the present invention relates to a vehicular lamp in which a first light source is disposed within a lamp chamber defined by a body and an outer cover, and a light guide that is disposed in front of the first light source guides light from a second light source differently from the first light source and radiates a portion of such light forward.

2. Related Art

There are known vehicular lamps such as tail lamps for automobiles that include a plurality of light sources capable of lighting in a predetermined combination. For example, in a tail light device described in Patent Document 1, light from a remote laser light source can be radiated forward from a light manifold, and light from a second light source (bank of LEDs) that is disposed rearward of the light manifold within a tail light assembly can pass through the light manifold and be radiated forward.

[Patent Document 1] Japanese Patent Application Laid-Open (Kokai) No. 2000-215710

### SUMMARY OF INVENTION

In such a tail light device, however, light from the second light source weakens when it passes through the light manifold. Therefore, the luminous efficiency of the second light source must be increased.

One or more embodiments of the present invention provide a vehicular lamp comprising: a body that opens forward; an outer cover that is attached to the body so as to cover the opening; a first light source that is disposed within a lamp chamber formed from the body and the outer cover; an optical member that reflects first light source light from the first light source forward; a second light source that is disposed within the lamp chamber; and a light guide in which an end portion thereof receives second light source light from the second light source and an extended side surface thereof radiates forward at least a portion of the second light source light, wherein the light guide is provided at a position that does not block a light component that forms a main light distribution of the first light source light.

In the vehicular lamp above, it is preferable that the light guide is provided in a plurality, with the plurality of light guides provided parallel to, and separate from one another, forward of the optical member within the lamp chamber, and also preferable that the optical member reflects the first light source light such that the light component that forms the main light distribution passes between the plurality of light guides.

In the vehicular lamp above, it is preferable that the light guide is shaped as a bar that extends parallel to a plane perpendicular to an optical axis of the main light distribution, and also preferable that the optical member condenses the first light source light so as to connect with a focal point in the vicinity of the light guide.

In the vehicular lamp above, it is preferable that the optical member has a transmission portion that is disposed forward of the first light source and transmits the first light source light, and also preferable that the light guide is provided at a position that does not block transmitted light that is transmitted through the transmission portion.

In the vehicular lamp above, the first light source may be a semiconductor light-emitting element that emits the first light source light forward around an optical axis.

Those skilled in the art will appreciate that, in one or more embodiments, the invention may also be practiced through sub-combinations of groups of the characteristics recited above.

A vehicular lamp according to one or more embodiments of the present invention excels in terms of designability by providing a light guide that can emit light from a second light source that is separate from a first light source, i.e., a main light source of the lamp. In addition, visibility of a lighting state of the first light source can be improved by providing the light guide at a position that does not block a main light distribution that is critical for visual observation of the lighting state of the first light source.

Other aspects and advantages of the invention will be apparent from the following description, the drawings and the claims.

### BRIEF DESCRIPTION OF DRAWINGS

FIG. 1 is a frontal view of a vehicular lamp 100 according to an embodiment of the present invention.

FIG. 2 is a cross-sectional view taken along a line A-A in FIG. 1.

FIG. 3 is a cross-sectional view taken along a line B-B in FIG. 1.

FIG. 4 is a cross-sectional view taken along a line C-C in FIG. 1.

FIG. 5 is a drawing showing a portion of a light path of first light source light in the cross-sectional view taken along the line A-A in FIG. 1.

FIG. 6 is a frontal view of a vehicular lamp 101 according to the example of another embodiment of the present invention.

FIG. 7 is a drawing showing a portion of a light path of the first light source light in a cross-sectional view taken along a line D-D in FIG. 6.

FIG. 8 is a frontal view of a vehicular lamp 102 according to the example of yet another embodiment of the present invention.

FIG. 9 is a drawing showing a portion of a light path of the first light source light in a cross-sectional view taken along a line E-E in FIG. 8.

FIG. 10 is a frontal view of a vehicular lamp 103 according to the example of yet another embodiment of the present invention.

FIG. 11 is a drawing showing a portion of a light path of the first light source light in a cross-sectional view taken along a line F-F in FIG. 10.

FIG. 12 is a frontal view of a vehicular lamp 200 according to the example of yet another embodiment of the present invention.

FIG. 13 is a cross-sectional view taken along a line X-X in FIG. 12.

FIG. 14 is a cross-sectional view taken along a line Y-Y in FIG. 12.

FIG. 15 is a drawing showing a portion of a light path of the first light source light in the cross-sectional view taken along the line Y-Y in FIG. 12.

### DETAILED DESCRIPTION

Hereinafter, embodiments of the present invention will be described with reference to the accompanying drawings. The following embodiments are merely exemplary, and all of the combinations of characteristics in the embodiments are not necessarily required in every embodiment.

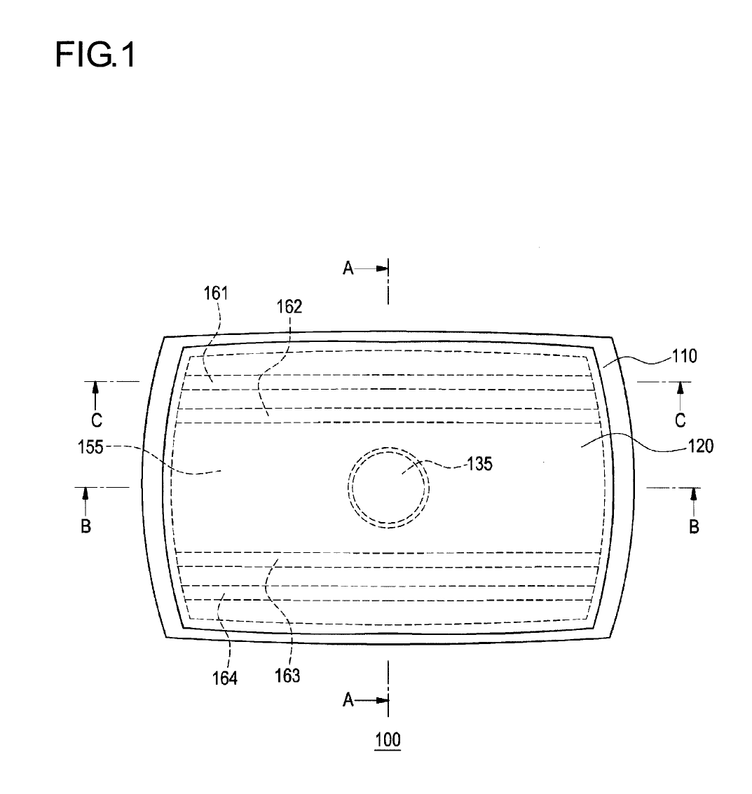

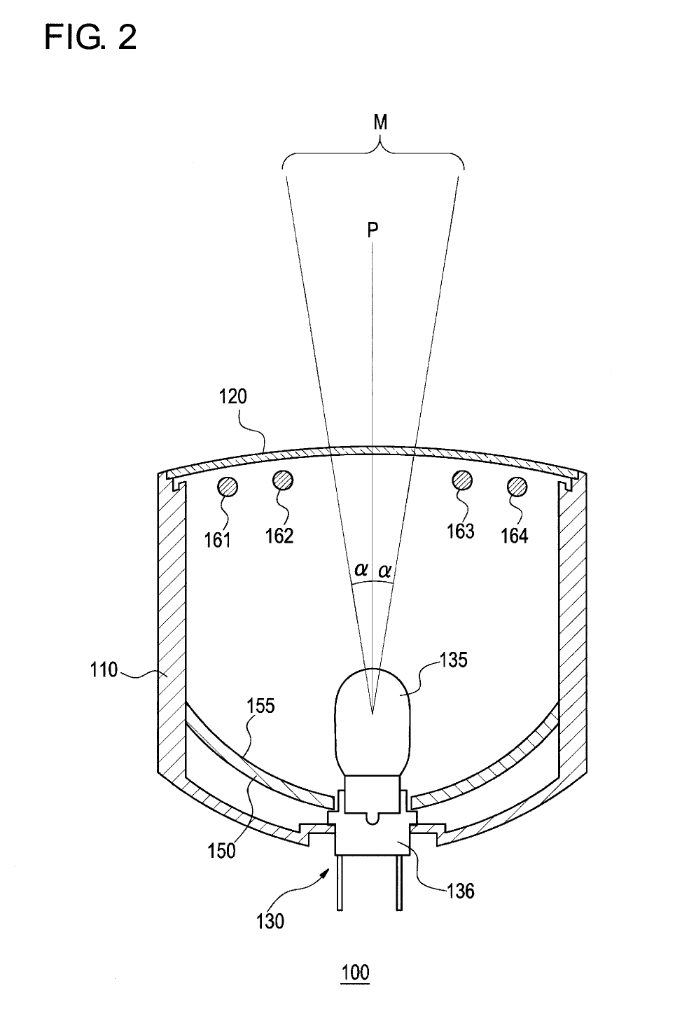

FIG. 1 is a frontal view of a vehicular lamp 100 according to an embodiment of the present invention. FIGS. 2 to 4 are cross-sectional views taken along lines A-A, B-B, and C-C, respectively, in FIG. 1.

The vehicular lamp 100 has an exterior formed from a body 110 of which a lamp front side (that is, a forward side) is open, and an outer cover 120 that is attached to the body 110 so as to cover the opening. Inside a lamp chamber formed from the body 110 and the outer cover 120, a first light source 130, a reflector 150, and a plurality of light guides 161, 162, 163, 164 are disposed. In the present example, the first light source 130 is disposed generally at the center of the lamp chamber, while the reflector 150 is disposed rearward of a light-emitting portion 135 of the first light source 130. The light guides 161 to 164 are disposed adjacent to an inner side of the outer cover 120 within the lamp chamber.

Note that, in the present specification, “forward” is a direction heading toward the outer cover 120 from the first light source 130 of the vehicular lamp 100 (e.g., upward in FIG. 2) and “rearward” is the direction opposite of forward (e.g., downward in FIG. 2). If the vehicular lamp 100 is used in a rear combination lamp of an automobile, “forward” as defined above will mean rearward of the vehicle.

The body 110 is integrally formed of a synthetic resin material, for example. The synthetic resin material is preferably polycarbonate resin (PC resin), polycarbonate ABS resin (PC-ABS resin), acrylic resin (PMMA), or the like. A portion of the body 110 corresponding to the lamp chamber is formed into a recessed shape, and an anchor groove that secures an outer peripheral edge portion of the outer cover 120 is formed on an opening peripheral edge portion of the body 110 on the forward side.

The outer cover 120 is formed of a transparent or semi-transparent synthetic resin material, for example. The synthetic resin material is preferably polycarbonate resin (PC resin), polycarbonate ABS resin (PC-ABS resin), acrylic resin (PMMA), or the like. The outer cover 120 is secured to the body 110 by adhesion or welding with the outer peripheral edge portion of the outer cover 120 fitted in the anchor groove of the body 110.

The light-emitting portion 135 of the first light source 130 emits light using a lighting voltage delivered through a power feed terminal provided on the rearward side of a socket portion 136. In the present example, an incandescent bulb or a halogen bulb, for example, is used as the first light source 130.

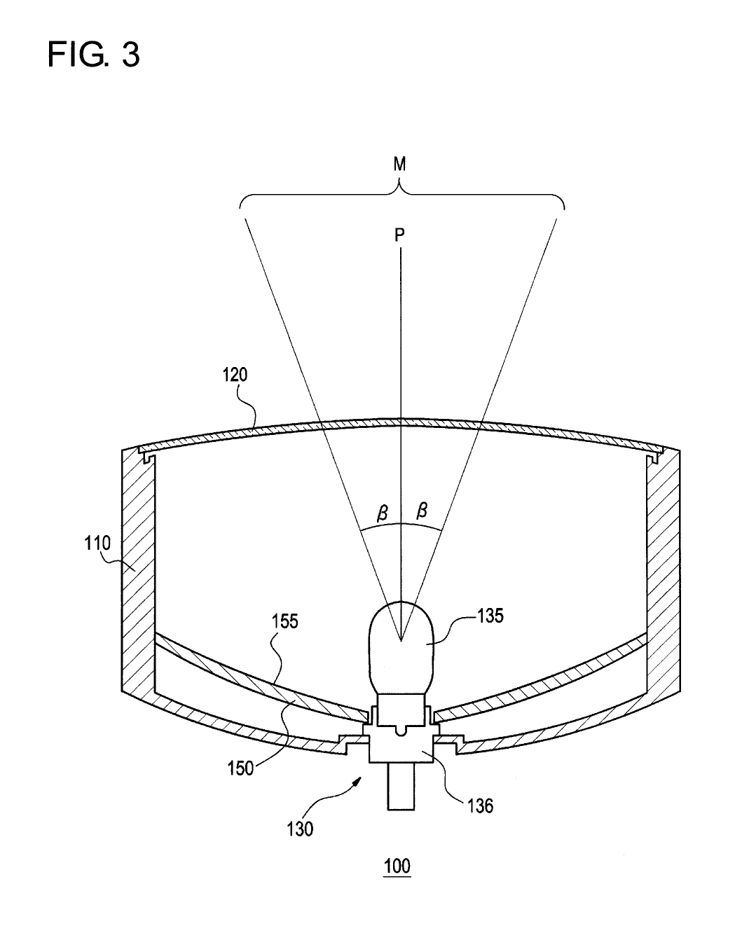

A portion of light from the first light source 130 is radiated from the forward side (upward side in FIG. 2) of the light-emitting portion 135, and becomes direct light that proceeds forward while diffusing from an optical axis indicated by “P” in FIGS. 2 and 3. Another portion of light from the first light source 130 is radiated sideward of the light-emitting portion 135, and becomes reflected light that proceeds forward after being reflected by the reflector 150 described later. In the following description, light from the light-emitting portion 135 of the first light source 130 is called “first light source light.”

The reflector 150 is an example of an optical member in one or more embodiments of the present invention, and has on a forward side thereof a reflective surface 155 that is recessed into a generally parabolic shape. In addition, a through hole for accommodating the first light source 130 is provided at the general center of the reflector 150. The reflective surface 155 mainly collects and reflects forward the first light source light from sideward of the light-emitting portion 135.

The light guides 161 to 164 are shaped as bars having circular cross sections in the present example, and are provided parallel to, and separate from one another, in the vicinity of the opening of the body 110. The light guides 161 to 164 are formed of a transparent or semi-transparent synthetic resin material, for example.

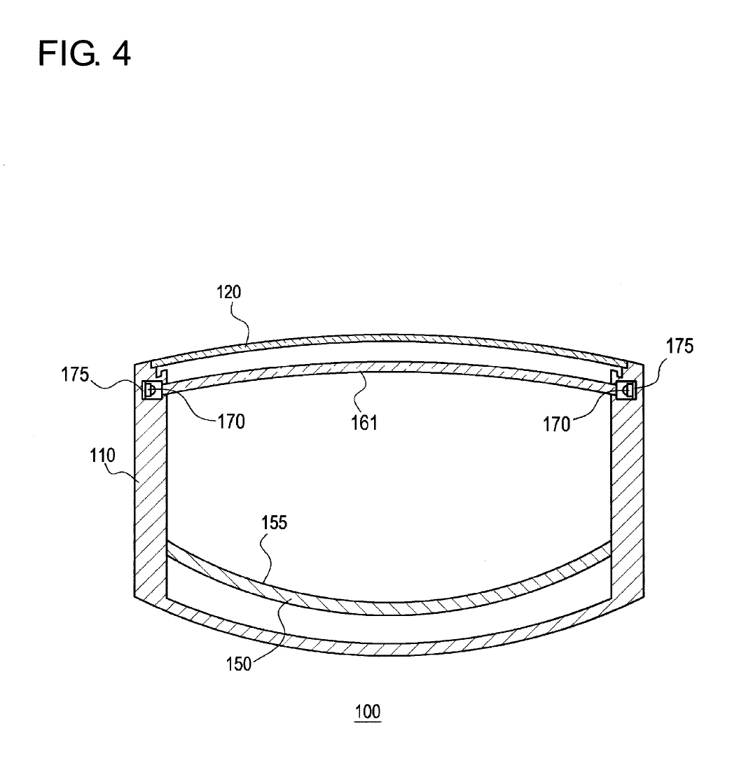

Both sides of the body 110 are provided with a second light source 170 that corresponds to each of the light guides 161 to 164. A semiconductor light-emitting element, such as an LED or the like, is preferably used for the second light source 170. Each of the second light sources 170, as illustrated in FIG. 4, is provided such that a light-emitting surface thereof faces respective end portions of the light guides 161 to 164, and is fixed to a substrate 175. The substrate 175 is formed with a control circuit that controls a light emission current delivered from an external power source, and the second light source 170 emits light using the light emission current delivered through the substrate 175. In the following description, light from the second light source 170 is called “second light source light.”

When the second light source 170 is lit, the second light source light emitted from the second light source 170 is incident to inside the light guides 161 to 164 from the respective end portions of the light guides 161 to 164. The second light source light then proceeds to advance while internally reflecting inside the light guides 161 to 164, and radiates from side surfaces of the light guides 161 to 164.

Note that, in the present example, the second light source light is radiated in all directions from the side surfaces of the light guides 161 to 164. However, the light guides 161 to 164 may be configured so as to radiate the second light source light in a specific direction. For example, the second light source light can be radiated only forward by providing steps on portions other than the forward side of the side surfaces of the light guides 161 to 164, or by forming a reflective surface through vapor deposition on such portions.

When the vehicular lamp 100 is viewed from the front side (forward side of the vehicular lamp 100) with the first light source 130 lit, the direct light from the first light source 130 and the reflected light from the reflector 150 are seen. Among such light, a light component within a specific range centered on the optical axis P of the first light source 130 is particularly important with respect to visibility of a lighting state of the first light source 130.

In the following description, this range is called a main light distribution area, and a light component inside the range is called a main light distribution. In the present example, the main light distribution area is defined as follows. Specifically, the main light distribution area is defined as an area within a range (a range indicated by “M” in FIG. 2) of an angle α with respect to the optical axis P around a center of light emission of the first light source 130 in at least a lamp vertical direction (up-down direction in FIG. 1), and within a range (a range indicated by “M” in FIG. 3) of an angle β with respect to the optical axis P around a center of light emission of the first light source 130 in a lamp horizontal direction (right-left direction in FIG. 1). Note that the magnitudes of the angle α and the angle β are preferably 10 degrees for the angle α and 20 degrees for the angle β, but may differ depending on the light radiation intensity of the first light source 130, the application of the vehicular lamp 100, and the like.

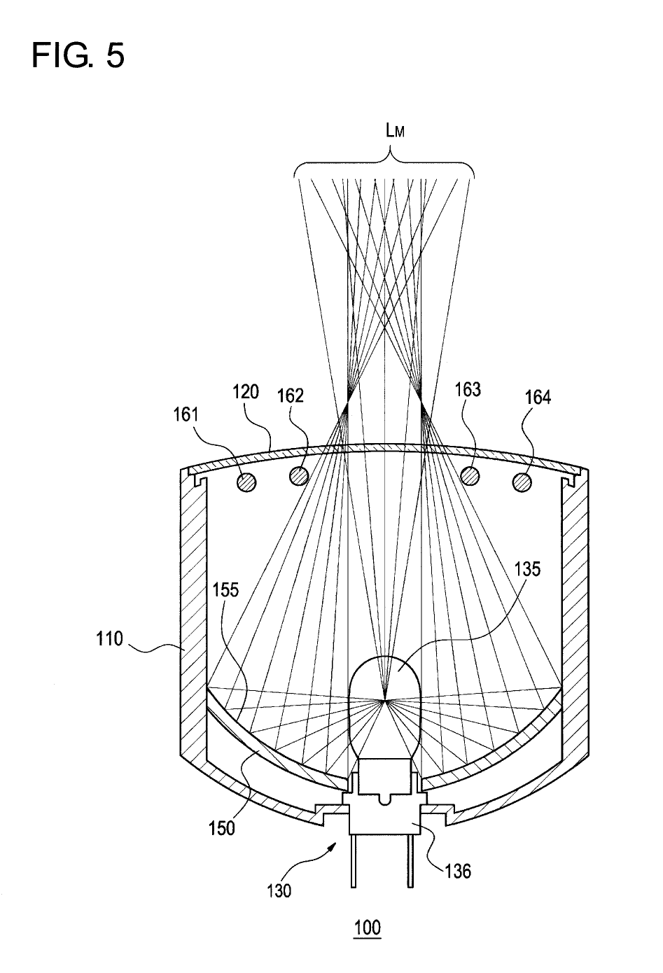

FIG. 5 is a drawing showing a portion of a light path of the first light source light in the cross-sectional view taken along the line A-A in FIG. 1. FIG. 5 shows only the light path of the light component within the main light distribution area (see FIG. 2) of the direct light from the first light source 130.

In the present example, the light guides 161 to 164 are all disposed parallel on a plane perpendicular to the optical axis (P) of the main light distribution. In addition, the light guides 161 to 164 are provided at positions that do not block at least the light component included in the main light distribution among the direct light from the first light source 130 and the reflected light that is reflected by the reflector 150. That is, the light component indicated by “L_{M}” in FIG. 5 is radiated forward without being blocked by the light guides 161 to 164.

Note that, in the present example, the light guides 161 to 164 are provided at positions that block practically none of the reflected light from the reflector 150, as mentioned above. However, the light guides 161 to 164 are not limited to this configuration, and may be provided in any manner so long as the light guides 161 to 164 are provided at positions that do not block at least the light component ultimately seen as the main light distribution L_{M} among the reflected light and the direct light.

Thus, the vehicular lamp 100 excels in terms of designability by providing the light guides 161 to 164 that can emit light from the second light source 170 that is separate from the first light source 130, i.e., the main light source. By providing the light guides 161 to 164 in the vehicular lamp 100 at positions that do not block the main light distribution L_{M}, which is critical for visual observation of the lighting state of the first light source 130, the light intensity of the main light distribution L_{M} is greater compared to when the light guides 161 to 164 are provided in the main light distribution area M of the first light source light and the lighting state of the first light source 130 has excellent visibility.

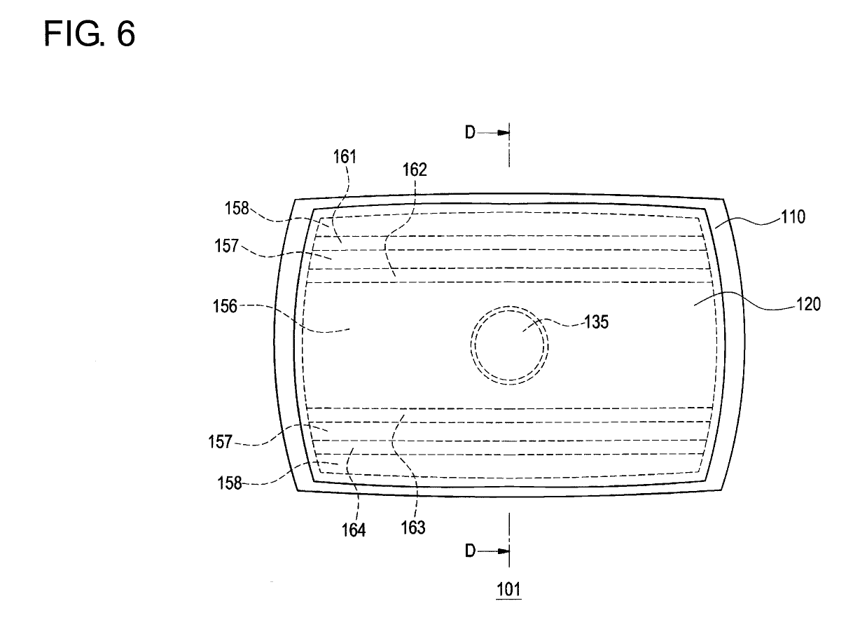

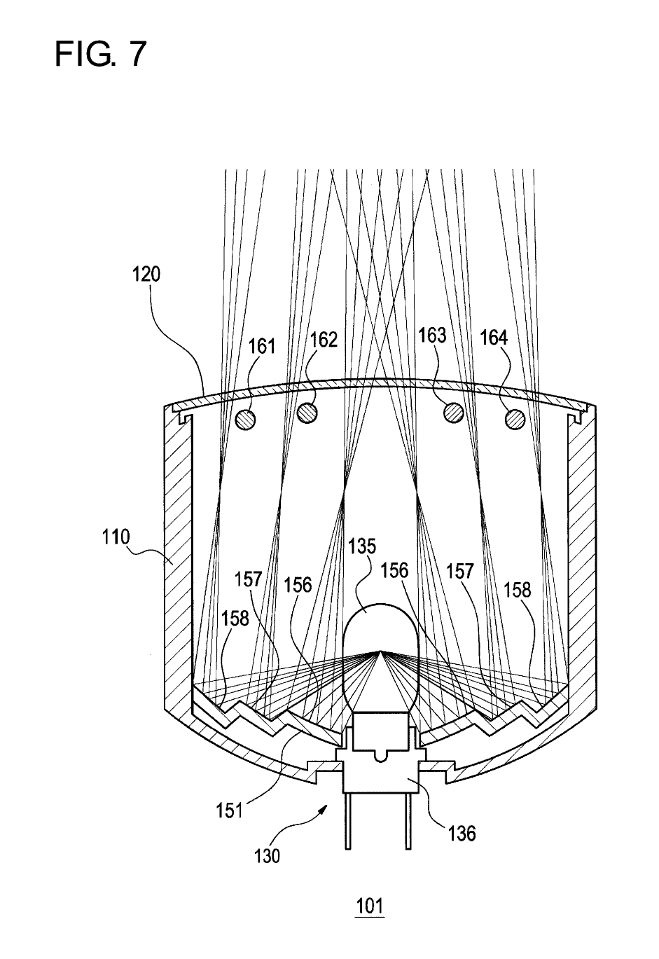

FIG. 6 is a frontal view of a vehicular lamp 101 according to the example of another embodiment of the present invention. FIG. 7 is a drawing showing a portion of a light path of reflected light from a reflector 151 in a cross-sectional view taken along a line D-D in FIG. 6.

With respect to the vehicular lamp 101 described below, configurations similar to the vehicular lamp 100 above will be denoted by like reference numerals in the drawings and will not be described further here. The light path of direct light from the first light source 130 of the vehicular lamp 101 is similar to that of the vehicular lamp 100 and is, therefore, not shown in FIG. 7.

The vehicular lamp 101 has a reflector 151 in place of the reflector 150 of the vehicular lamp 100. The reflector 151 is another example of the optical member in the present invention, and has on a forward side thereof a plurality of reflective surfaces 156, 157, 158 that is recessed into a generally parabolic shape as shown in FIG. 7.

The reflective surfaces 156 to 158 reflect forward the first light source light incident from the first light source 130. Here, each of the reflective surfaces 156 to 158 reflects the first light source light such that the reflected light passes between the light guides 161 to 164. More specifically, the reflective surfaces 156 to 158 reflect the first light source light such that an optical axis of the reflected light passes between the light guides 161 to 164. The reflective surfaces 156 to 158 also condense the reflected light such that the reflected light connects with a focal point in the vicinity of any one of the light guides 161 to 164. Accordingly, the reflected light that is reflected by each of the reflective surfaces 156 to 158 is radiated forward without being blocked by any one of the light guides 161 to 164.

Thus, by including in the vehicular lamp 101 the reflector 151, which is provided with the reflective surfaces 156 to 158 that reflect the first light source light so as to pass between the light guides 161 to 164, the proportion of the first light source light blocked by the light guides 161 to 164 can be further reduced. Consequently, the lighting state of the first light source 130 has excellent visibility.

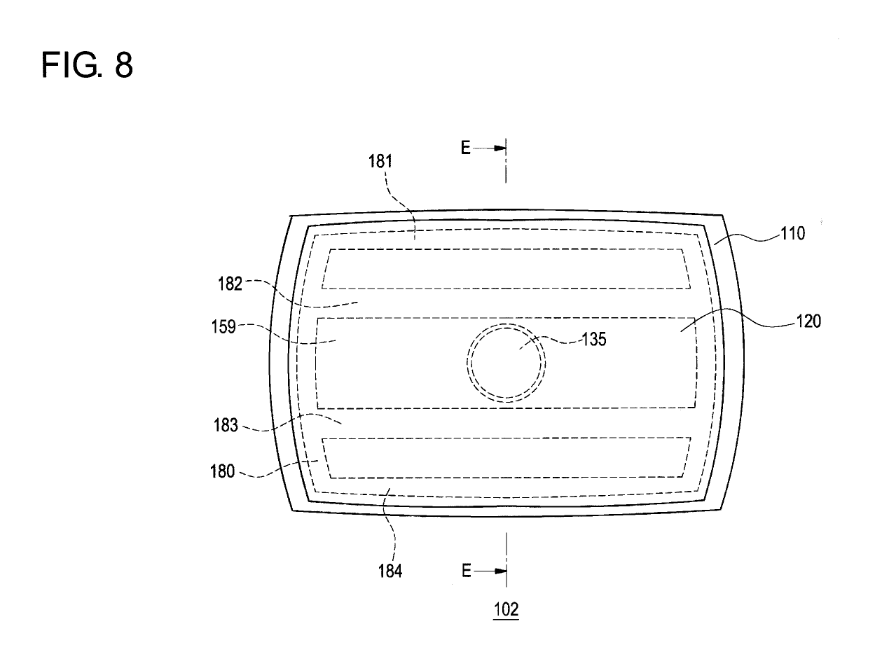

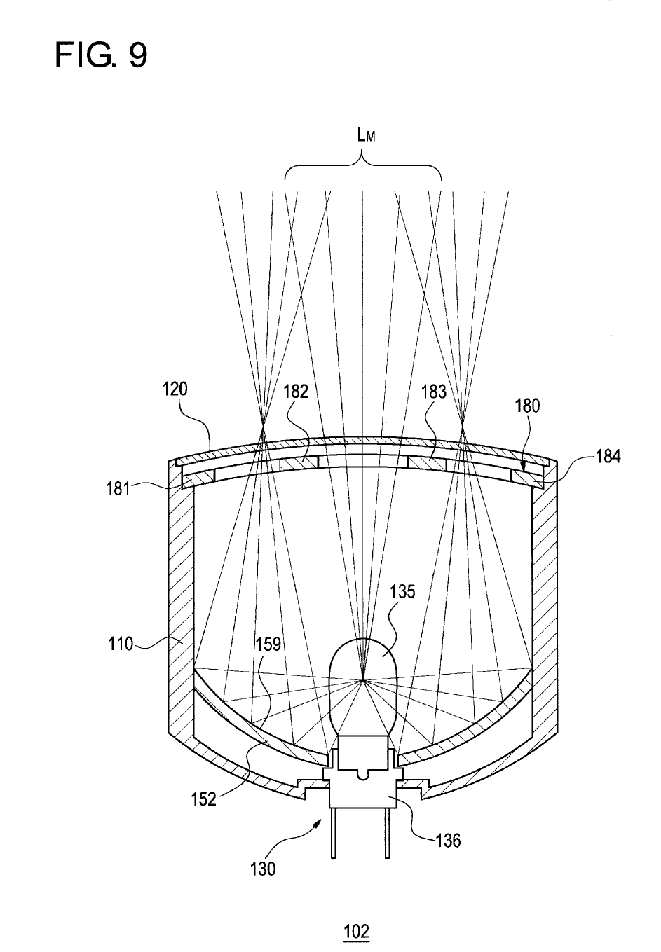

FIG. 8 is a frontal view of a vehicular lamp 102 according to the example of yet another embodiment of the present invention. FIG. 9 is a drawing showing a portion of a light path of the first light source light in a cross-sectional view taken along a line E-E in FIG. 8. With respect to the vehicular lamp 102 described below, configurations similar to the vehicular lamp 100 above will be denoted by like reference numerals in the drawings and will not be described further here.

The vehicular lamp 102 has a reflector 152 and a light guide 180 in place of the reflector 150 and the light guides 161 to 164 of the vehicular lamp 100. The light guide 180 serves as an inner lens member integrally formed of a transparent or semi-transparent synthetic resin and is disposed adjacent to the inner side of the outer cover 120 within the lamp chamber of the vehicular lamp 102. The light guide also includes a plurality of light guide portions 181, 182, 183, 184.

The light guide portions 181 to 184 are disposed parallel to a plane perpendicular to the optical axis of the main light distribution of the first light source light, and also provided parallel to and separate from one another. An upper surface and a lower surface of the light guide portions 181 to 184 are generally parallel to the above plane. As shown in FIGS. 8 and 9, through holes for allowing the first light source light to pass through are provided between the light guide portions 181 to 184.

Note that, although not shown in the drawings, both sides of the body 110 are provided with a plurality of the second light sources 170 at positions facing both ends of the light guide portions 181 to 184. Accordingly, the light guide portions 181 to 184 emit light due to the second light source light from the second light source 170. In addition, at such time, a portion other than the light guide portions 181 to 184 in the light guide 180, e.g., a frame portion that connects the light guide portions 181 to 184 in the light guide 180, also emits light due to the second light source light.

The light guide 180 of the present example takes up more surface area of the opening surface of the body 110 compared to the light guides 161 to 164 provided in the vehicular lamps 100, 101. Thus, a light emission image different from that of the vehicular lamps 100, 101, which are provided with the bar-shaped light guides 161 to 164, can be created with the second light source light.

The reflector 152 is yet another example of the optical member in the present invention, and has, on a forward side thereof, a reflective surface 159 that is recessed into a generally parabolic shape. The reflective surface 159 reflects forward the first light source light incident from the first light source 130. Here, the reflective surface 159 reflects the first light source light such that the reflected light passes through the through holes between the light guides 181 to 184.

More specifically, the reflective surface 159 reflects the first light source light such that the optical axis of the reflected light passes through the above through holes. The reflective surface 159 also condenses the reflected light such that the reflected light connects with a focal point in the vicinity of the through holes. Accordingly, the reflected light that is reflected by the reflective surface 159 is radiated forward without being blocked by the light guide 180. In addition, the light component within the main light distribution area among the direct light from the first light source 130 passes through the through hole provided between the light guide portion 182 and the light guide portion 183, and radiates forward as shown in FIG. 9.

Accordingly, even though the vehicular lamp 102 has the light guide 180 that takes up more surface area of the opening surface of the body 110 as compared to the light guides 161 to 164 provided in the vehicular lamps 100, 101, there is no drop in the forward radiation efficiency of the first light source light. Thus, the main light distribution can be efficiently radiated forward.

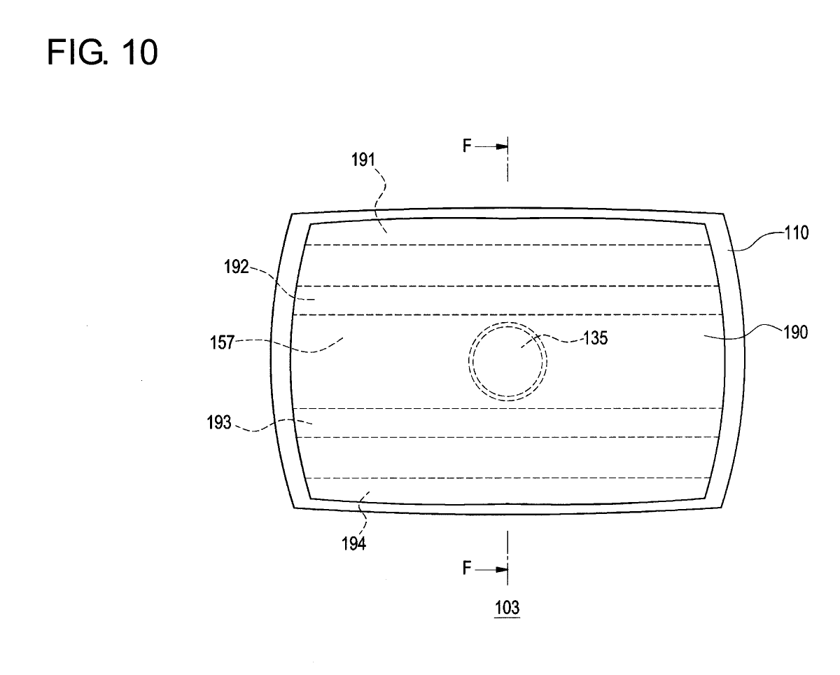

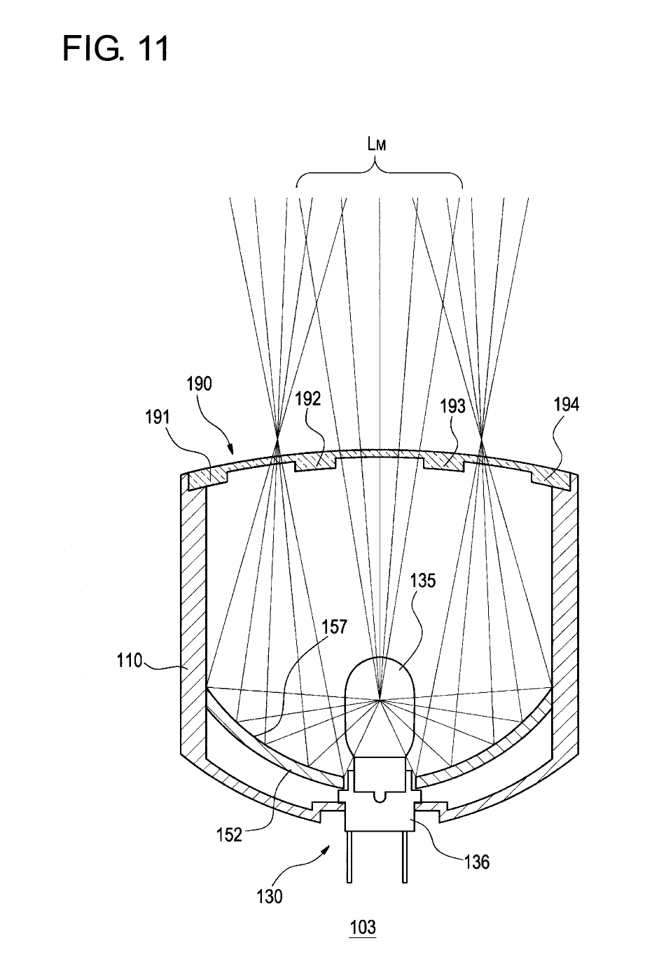

FIG. 10 is a frontal view of a vehicular lamp 103 according to the example of yet another embodiment of the present invention. FIG. 11 is a drawing showing a portion of a light path of the first light source light in a cross-sectional view taken along a line F-F in FIG. 10. The vehicular lamp 103 differs from the vehicular lamps 100 to 102 above in that the vehicular lamp 103 has a light guide 190 that is integrally provided with the outer cover.

The light guide 190 has a plurality of light guide portions 191, 192, 193, 194 that are formed thicker in the direction of the optical axis of the first light source light than other portions. The light guide portions 191 to 194 are disposed parallel to a plane perpendicular to the optical axis of the main light distribution of the first light source light, and also provided parallel to and separate from one another. An upper surface and a lower surface of the light guide portions 191 to 194 are generally parallel to the above plane. The light guide portions 191 to 194 emit light due to the second light source light from the plurality of second light sources 170 (not shown) that are provided on both sides of the body 110.

At such time, portions other than the light guide portions 191 to 194 in the light guide 190 also slightly emit light due to the second light source light. Accordingly, when the second light source 170 is lit, the overall front of the vehicular lamp 103 emits light due to the second light source light. Therefore, a light emission image different from that of the vehicular lamps 100 to 102 can be created.

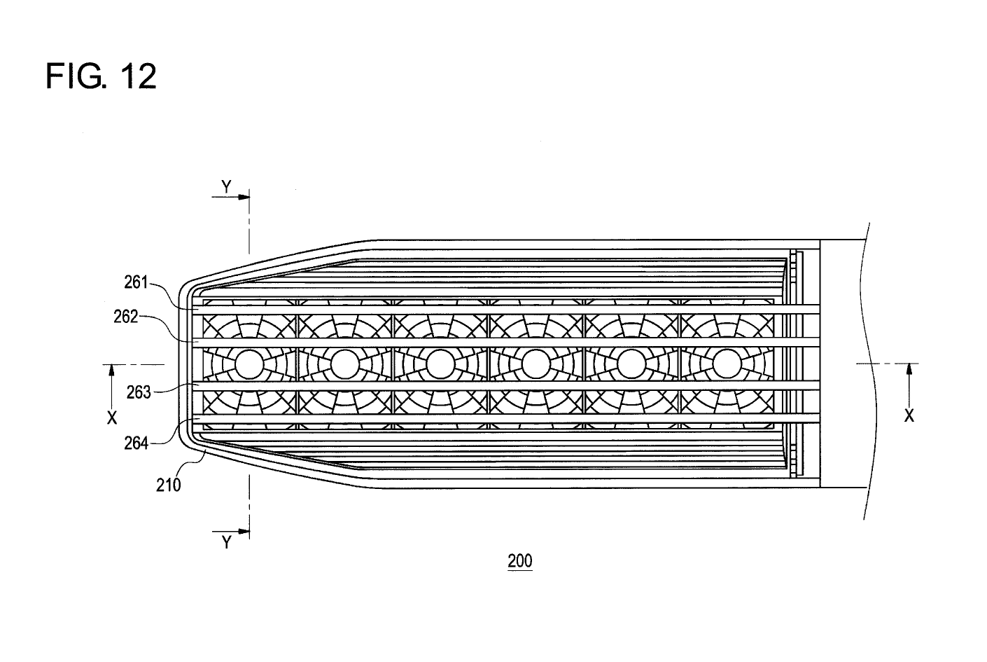

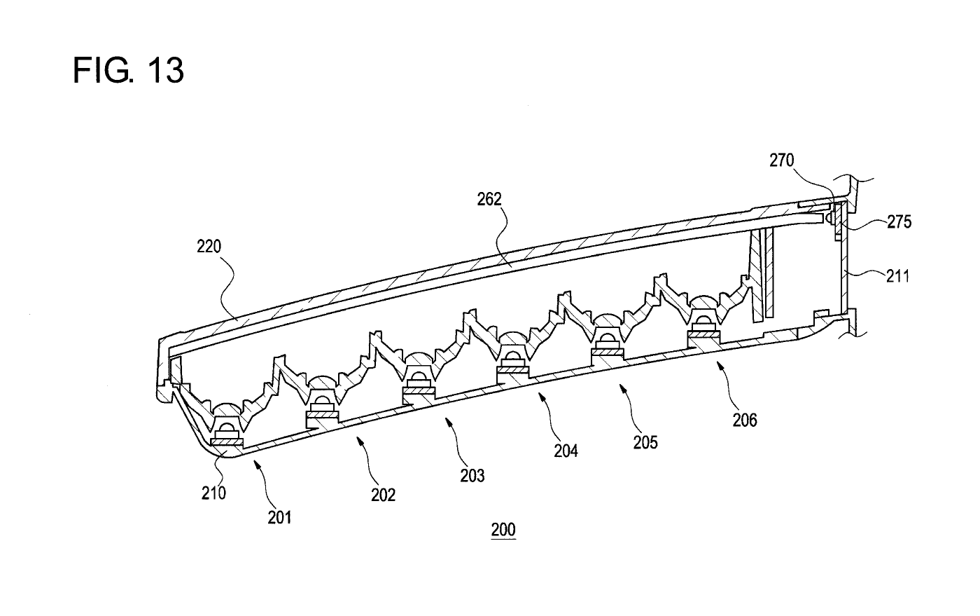

FIG. 12 is a frontal view of a vehicular lamp 200 according to the example of yet another embodiment of the present invention. FIG. 13 is a cross-sectional view taken along a line X-X in FIG. 12.

The vehicular lamp 200 has an exterior formed from a body 210 of which a lamp front side (that is, a forward side) is open, and an outer cover 220 that is attached to the body 210 so as to cover the opening. Inside a lamp chamber formed from the body 210 and the outer cover 220, a plurality of lighting units 201, 202, 203, 204, 205, 206 is disposed.

In addition, a plurality of light guides 261, 262, 263, 264 is disposed on an inner side of the outer cover 220 within the lamp chamber. The light guides 261 to 264 are shaped as bars having generally oblong cross sections, and are provided along an inner surface of the outer cover 220. The light guides 261 to 264 are also provided parallel to, and separate from one another, in a planar direction of the outer cover 220. The light guides 261 to 264 are formed of a transparent or semi-transparent synthetic resin material, for example.

End sides of the light guides 261 to 264 are respectively provided with a second light source 270 that corresponds to each of the light guides 261 to 264. A semiconductor light-emitting element, such as an LED or the like, is preferably used for the second light source 270. Each of the second light sources 270, as illustrated in FIG. 13, is provided such that a light-emitting surface thereof faces respective end portions of the light guides 261 to 264, and is fixed to a substrate 275. The substrate 275 is formed with a control circuit that controls a light emission current delivered from an external power source, and is fixed to a divider 211 attached to the body 210. The second light source 270 emits light using the light emission current delivered through the substrate 275.

The second light source light emitted from the second light source 270 is incident to inside the light guides 261 to 264 from the respective end portions of the light guides 261 to 264. The second light source light then proceeds to advance while internally reflecting inside the light guides 261 to 264, and radiates from side surfaces of the light guides 261 to 264 to a surrounding area.

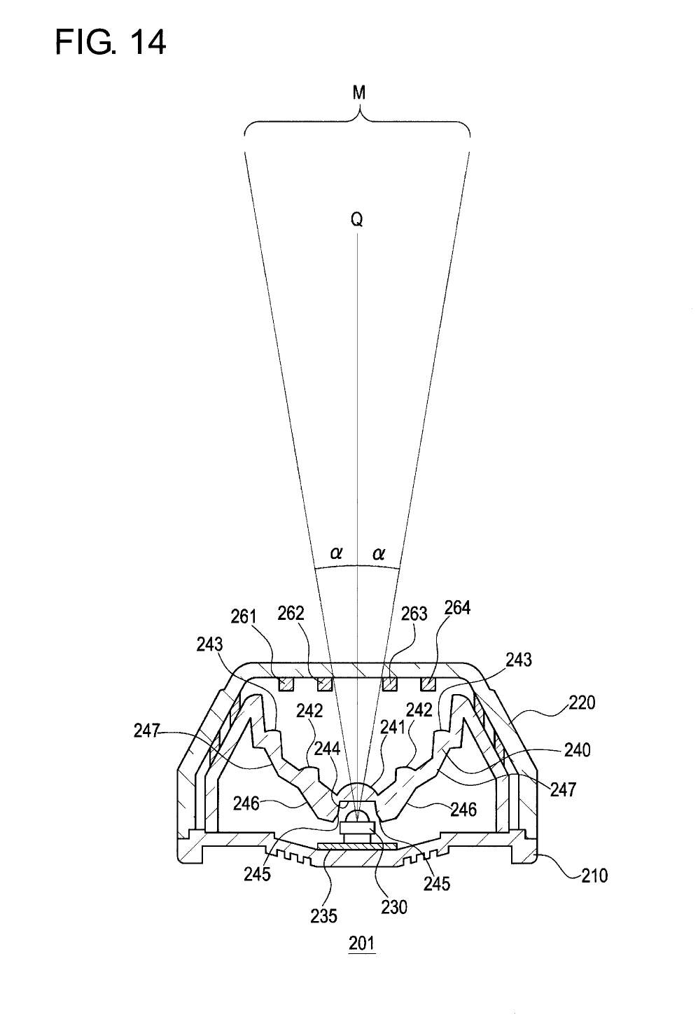

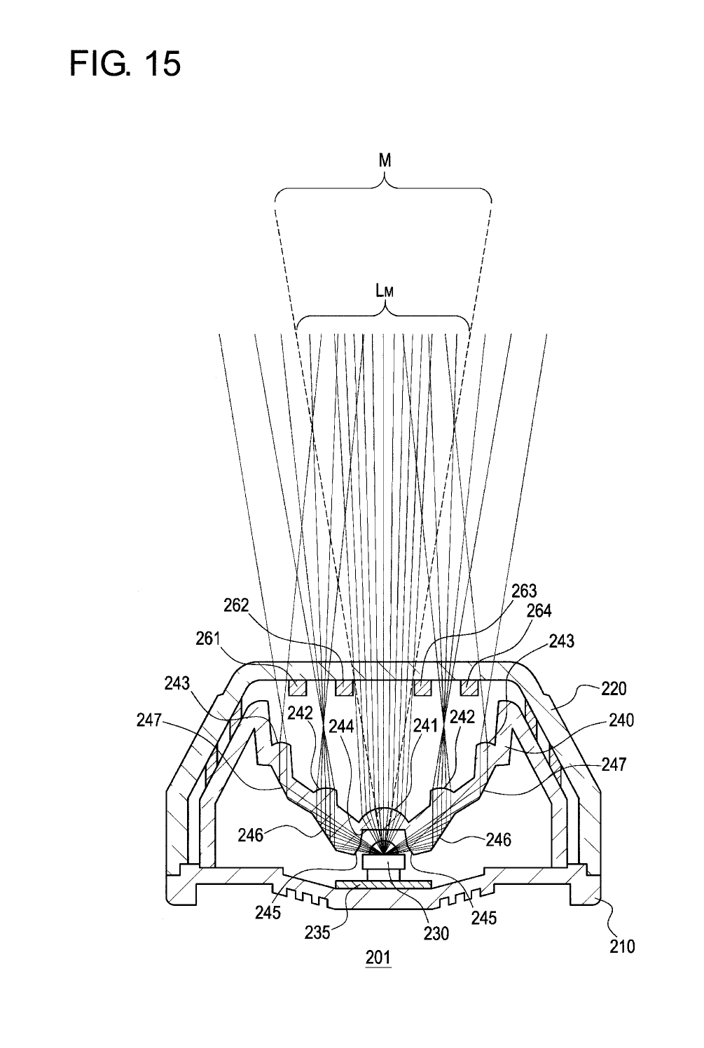

The plurality of lighting units 201 to 206 each have generally the same configuration, and are provided together along a lengthwise direction of the vehicular lamp 200. In the following description, the lighting unit 201 will be explained with reference to FIGS. 14 and 15. The other lighting units 202 to 206 will not be explained here because they are similar to the lighting unit 201 described below.

FIG. 14 is a cross-sectional view taken along a line Y-Y in FIG. 12. FIG. 15 is a drawing showing a portion of a light path of the first light source light in the cross-sectional view taken along the line Y-Y in FIG. 12. As shown in FIG. 14, the lighting unit 201 includes a first light source 230 that is disposed at the center of a bottom surface of the body 210, and an optical member 240 that is disposed forward of the first light source 230.

The first light source 230 is a semiconductor light-emitting element, such as an LED or the like, and a light-emitting surface thereof is provided so as to face a horizontal incident surface 244 that is provided at the center of the optical member 240. In addition, the first light source 230 is fixed to a substrate 235 that is disposed on the bottom surface of the body 210. The substrate 235 is formed with a control circuit that controls a light emission current delivered from an external power source, and the first light source 230 emits light using the light emission current delivered through the substrate 235. In the following description, light from the first light source 230 is called “first light source light.”

The optical member 240 includes incident surfaces 244, 245 to which the first light source light is incident from the first light source 230; a radiating surface 241 that radiates the first light source light incident to the incident surface 244; reflective surfaces 246, 247 that internally reflect the first light source light incident to the incident surface 245; a radiating surface 242 that radiates the first light source light reflected by the reflective surface 246; and a radiating surface 243 that radiates the first light source light reflected by the reflective surface 247.

Among the first light source light from the first light source 230, light centered on an optical axis (a straight line extending in a lamp longitudinal direction and indicated by “Q” in FIG. 14) of the first light source 230 and radiated forward is incident to the incident surface 244 of the optical member 240. The first light source light incident to the incident surface 244 becomes generally parallel light due to the radiating surface 241 having a convex lens shape, and is radiated forward as shown in FIG. 15.

Accordingly, a portion interposed between the incident surface 244 and the radiating surface 241 of the optical member 240 functions as a transmission portion that transmits the first light source light. In the following description, the first light source light from the first light source 230 that passes through the transmission portion of the optical member 240 and radiates from the radiating surface 241 is called “direct light.”

Among the first light source light from the first light source 230, light radiated diagonally forward and sideward of the first light source 230 is incident to the incident surface 245 of the optical member 240. The first light source light incident to the incident surface 245 is internally reflected by the reflective surfaces 246, 247 toward the radiating surfaces 242, 243 as shown in FIG. 15.

The first light source light reflected by the reflective surfaces 246, 247 is condensed in a prescribed manner by the radiating surfaces 242, 243 having convex lens shapes, and such light connects with focal points in the vicinity of the light guides 261 to 264 and passes between the light guides 261 to 264 to radiate forward. In the following description, the first light source light from the first light source 230 that passes through the incident surface 245 of the optical member 240 and radiates from the radiating surfaces 242, 243 is called “reflected light.”

When the lighting unit 201 is viewed from the front side with the first light source 230 lit, the direct light and the reflected light from the first light source 230 are seen. Among such light, a light component within a range (a range indicated by “M” in FIG. 14) of an angle α with respect to the optical axis Q around a center of light emission of the first light source 230 is the main light distribution L_{M}, which is particularly important with respect to visibility of a lighting state of the first light source 230. Note that the magnitude of the angle α is preferably 10 degrees, but may differ depending on the light intensity of the first light source 230, the application of the vehicular lamp 201, and the like.

In the lighting unit 201, the first light source light radiated forward from the first light source 230 as direct light accounts for the majority of the main light distribution L_{M}, and the light guides 261 to 264 are provided at positions that do not block the direct light. Accordingly, the light intensity of the main light distribution L_{M} is greater compared to when the light guides 261 to 264 are provided within the main light distribution area of the first light source light, and the lighting state of the first light source 230 has excellent visibility.

Further, in the lighting unit 201, the first light source light radiated diagonally upward and sideward from the first light source 230 is also radiated forward by the optical member 240 so as to pass between the light guides 261 to 264. Accordingly, the intensity of light radiated forward can be further increased compared to when the optical member 240 is not provided. Therefore, the visibility of the lighting state of the first light source 230 can be further improved.

While description has been made in connection with exemplary embodiments of the present invention, it will be obvious to those skilled in the art that various changes and modification may be made therein without departing from the present invention. It is aimed, therefore, to cover in the appended claims all such changes and modifications falling within the true spirit and scope of the present invention.

### DESCRIPTION OF THE REFERENCE NUMERALS

100, 101, 102, 103, 200 VEHICULAR LAMP
110, 210 BODY
120, 220 OUTER COVER
130, 230 FIRST LIGHT SOURCE
135 LIGHT-EMITTING PORTION
136 SOCKET PORTION
150, 151, 152 REFLECTOR
155, 156, 157, 158, 159 REFLECTIVE SURFACE
161, 162, 163, 164, 180, 190, 261, 262, 263, 264 LIGHT GUIDE
170, 270 SECOND LIGHT SOURCE
175, 235, 275 SUBSTRATE
201, 202, 203, 204, 205, 206 LIGHTING UNIT
211 DIVIDER
240 OPTICAL MEMBER
241, 242, 243 RADIATING SURFACE
244, 245 INCIDENT SURFACE
246, 247 REFLECTIVE SURFACE

What is claimed is:

1. A vehicular lamp comprising:
a body that opens forward;
an outer cover attached to the body so as to cover the opening;
a first light source disposed within a lamp chamber formed from the body and the outer cover;
an optical member that reflects first light source light from the first light source forward;
a second light source disposed within the lamp chamber; and
a light guide in which an end portion thereof receives second light source light from the second light source and an extended side surface thereof radiates forward at least a portion of the second light source light,
wherein the light guide is provided at a position that does not block a light component that forms a main light distribution of the first light source light.

2. The vehicular lamp according to claim 1,
wherein the light guide is provided in a plurality, with the plurality of light guides provided parallel to, and separate from one another, forward of the optical member within the lamp chamber, and
wherein the optical member reflects the first light source light such that the light component that forms the main light distribution passes between the plurality of light guides.

3. The vehicular lamp according to claim 1,
wherein the light guide is shaped as a bar that extends parallel to a plane perpendicular to an optical axis of the main light distribution, and
wherein the optical member condenses the first light source light so as to connect with a focal point in the vicinity of the light guide.

4. The vehicular lamp according to claim 1,
wherein the optical member comprises a transmission portion disposed forward of the first light source and transmits the first light source light, and
wherein the light guide is provided at a position that does not block transmitted light that is transmitted through the transmission portion.

5. The vehicular lamp according to claim 4,
wherein the first light source is a semiconductor light-emitting element that emits the first light source light forward around an optical axis.

6. The vehicular lamp according to claim 2,
wherein the light guide is shaped as a bar that extends parallel to a plane perpendicular to an optical axis of the main light distribution, and
wherein the optical member condenses the first light source light so as to connect with a focal point in the vicinity of the light guide.

7. The vehicular lamp according to claim 2,
wherein the optical member comprises a transmission portion disposed forward of the first light source and transmits the first light source light, and
wherein the light guide is provided at a position that does not block transmitted light that is transmitted through the transmission portion.

8. The vehicular lamp according to claim 3,
wherein the optical member comprises a transmission portion disposed forward of the first light source and transmits the first light source light, and
wherein the light guide is provided at a position that does not block transmitted light that is transmitted through the transmission portion.

9. The vehicular lamp according to claim 6,
wherein the optical member comprises a transmission portion disposed forward of the first light source and transmits the first light source light, and
wherein the light guide is provided at a position that does not block transmitted light that is transmitted through the transmission portion.

10. The vehicular lamp according to claim 7,
wherein the first light source is a semiconductor light-emitting element that emits the first light source light forward around an optical axis.

11. The vehicular lamp according to claim 8,
wherein the first light source is a semiconductor light-emitting element that emits the first light source light forward around an optical axis.

12. The vehicular lamp according to claim 9,
wherein the first light source is a semiconductor light-emitting element that emits the first light source light forward around an optical axis.

13. A method of manufacturing a vehicular lamp comprising:
attaching an outer cover attached to a body that opens forward so as to cover the opening;
disposing a first light source within a lamp chamber formed from the body and the outer cover;
arranging an optical member to reflect first light source light from the first light source forward;
disposing a second light source within the lamp chamber; and
providing a light guide in which an end portion thereof receives second light source light from the second light source and an extended side surface thereof radiates forward at least a portion of the second light source light,
wherein the light guide is provided at a position that does not block a light component that forms a main light distribution of the first light source light.

14. The method according to claim 13,
wherein the light guide is provided in a plurality, with the plurality of light guides provided parallel to, and separate from one another, forward of the optical member within the lamp chamber, and
wherein the optical member reflects the first light source light such that the light component that forms the main light distribution passes between the plurality of light guides.

15. The method according to claim 13,
wherein the light guide is shaped as a bar that extends parallel to a plane perpendicular to an optical axis of the main light distribution, and
wherein the optical member condenses the first light source light so as to connect with a focal point in the vicinity of the light guide.

16. The method according to claim 13,
wherein the optical member comprises a transmission portion disposed forward of the first light source and transmits the first light source light, and
wherein the light guide is provided at a position that does not block transmitted light that is transmitted through the transmission portion.

17. The method according to claim 16,
wherein the first light source is a semiconductor light-emitting element that emits the first light source light forward around an optical axis.

18. The method according to claim 14,
wherein the light guide is shaped as a bar that extends parallel to a plane perpendicular to an optical axis of the main light distribution, and
wherein the optical member condenses the first light source light so as to connect with a focal point in the vicinity of the light guide.

19. The method according to claim 14,
wherein the optical member comprises a transmission portion disposed forward of the first light source and transmits the first light source light, and
wherein the light guide is provided at a position that does not block transmitted light that is transmitted through the transmission portion.

20. The method according to claim 15,
wherein the optical member comprises a transmission portion disposed forward of the first light source and transmits the first light source light, and
wherein the light guide is provided at a position that does not block transmitted light that is transmitted through the transmission portion.
